(19) United States
(12) Patent Application Publication
(10) Pub. No.: US 2015/0233758 A1
(43) Pub. Date: Aug. 20, 2015

(54) Electronic Fence Generator

(71) Applicant: EGENPOWER INC., Laguna Niguel, CA (US)

(72) Inventors: Yao-Hsi CHIU, Burnaby (CA); Fei-Yun ZHU, Shenzhen City (CN)

(21) Appl. No.: 14/626,479

(22) Filed: Feb. 19, 2015

(30) Foreign Application Priority Data
Feb. 20, 2014 (CN) 201410058172.4

(51) Int. Cl. G01J 1/04; A01D 34/00; G01J 1/42

(52) U.S. Cl. CPC G01J 1/0403; G01J 1/42; A01D 34/008

(57) ABSTRACT

An electronic fence generator includes a cylindrical body, a ground stake downwardly extended from the bottom of the cylindrical body, and an ultrasonic transmitter, an infrared transmitter and an infrared receiver mounted in the cylindrical body. The ultrasonic transmitter is adapted for transmitting an ultrasonic signal to create a collision avoidance range around the cylindrical body. The infrared transmitter is adapted for transmitting an infrared signal in a signal transmitting direction. The infrared receiver is adapted for receiving an infrared signal from another electronic fence generator in a signal receiving direction different from the signal transmitting direction. Thus, the electronic fence generator can be used for creating a virtual electronic fence for restricting an automatic lawn mower to the range defined by the electronic fence.

### BACKGROUND OF THE INVENTION

1. Field of the Invention

The present invention relates to an electronic fence technology and more particularly, to an electronic fence generator adapted for creating a virtual electronic fence to restrict an automatic lawn mower to the area defined by the electronic fence.

2. Description of the Related Art

During the operation of a conventional lawn mower, the user's forward pushing action makes the lawn mower to move forward, and the mower's steering direction is controlled subject to the user's direction of movement. This control method is time-consuming and laborious.

There is an automatic lawn mower available on the market that the user needs not to control its operation direction and, that uses its built-in program to control its operation path. Although an automatic mower is very easy to use, it is still likely to move out of its working area.

### SUMMARY OF THE INVENTION

The present invention has been accomplished under the circumstances in view. It is the main object of the present invention to provide an electronic fence generator for generating a virtual electronic fence to restrict an automatic lawn mower to the area defined by the electronic fence.

To achieve this and other objects of the present invention, an electronic fence generator comprises a cylindrical body, a ground stake downwardly extended from the bottom of the cylindrical body, and an ultrasonic transmitter, an infrared transmitter and an infrared receiver mounted in the cylindrical body. The ultrasonic transmitter is adapted for transmitting an ultrasonic signal to create a collision avoidance range around the cylindrical body. The infrared transmitter is adapted for transmitting an infrared signal in a signal transmitting direction. The infrared receiver is adapted for receiving an infrared signal from another electronic fence generator in a signal receiving direction different from the signal transmitting direction.

Thus, the user can fasten the ground stakes of four or more than four electronic fence generators to the ground, and utilize the ultrasonic signals and infrared signals transmitted by the electronic fence generators to create a closed virtual electronic fence. Thus, an automatic lawn mower capable of sensing ultrasonic signals and infrared signals can be restricted to the area defined by the electronic fence.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a schematic plain view of an electronic fence generator in accordance with the present invention.

FIG. 2 is a schematic elevational view illustrating five electronic fence generators arranged in an array.

### DETAILED DESCRIPTION OF THE INVENTION

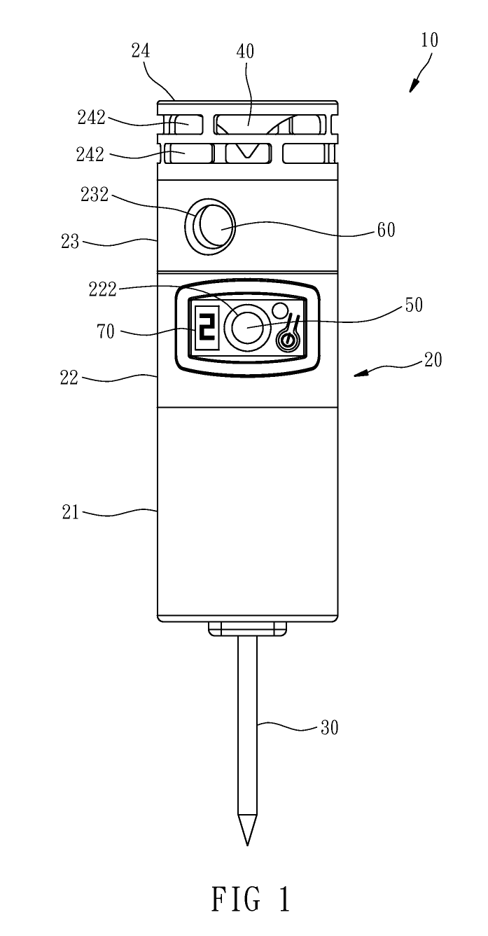

Referring to FIG. 1, an electronic fence generator 10 in accordance with the present invention is shown. The electronic fence generator 10 comprises a cylindrical body 20, a ground stake 30 downwardly extended from a bottom side of the cylindrical body 20, and an ultrasonic transmitter 40, an infrared transmitter 50 and an infrared receiver 60 mounted in the cylindrical body 20.

The cylindrical body 20 comprises a base 21 fixedly connected with the ground stake 30, a holder member 22 fixedly mounted on a top side of the base 21, a rotatable member 23 mounted on a top side of the holder member 22 and rotatable relative to the base 21 and the holder member 22, and a top cover 24 mounted on a top side of the rotatable member 23. The base 21, the holder member 22, the rotatable member 23 and the top cover 24 constitute a cylindrical housing that holds therein a circuit board and a battery (not shown) that are electrically coupled with the ultrasonic transmitter 40, the infrared transmitter 50 and the infrared receiver 60.

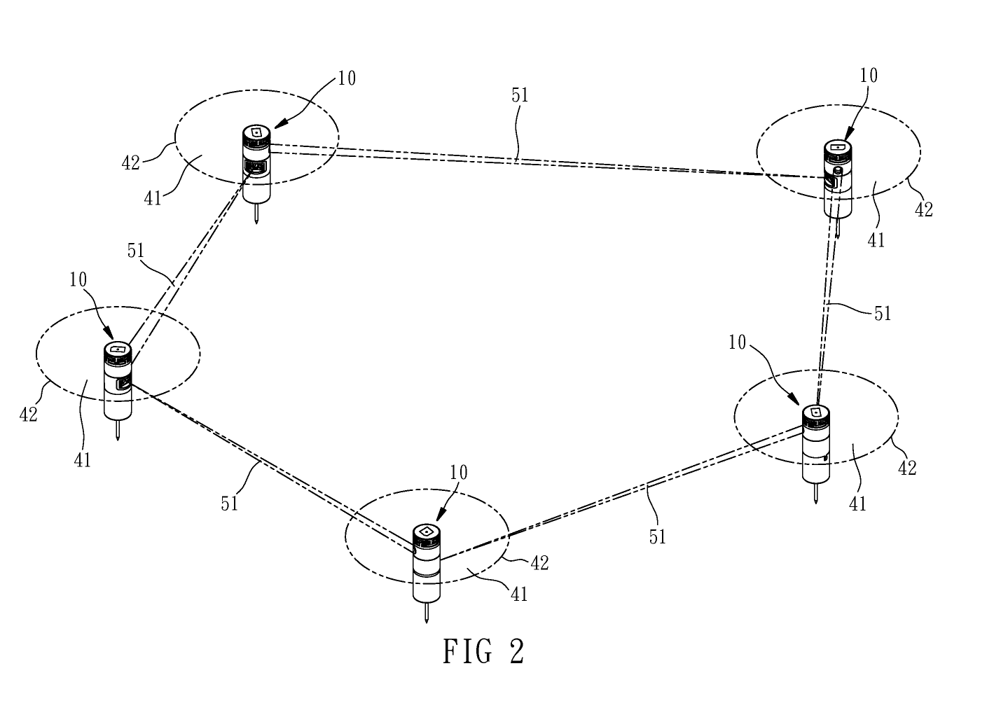

Referring to FIG. 2 and FIG. 1 again, the ultrasonic transmitter 40 is mounted in the top cover 24, and adapted for transmitting an ultrasonic signal 41 through multiple openings 242 in the peripheral wall of the top cover 24 toward the outside. The ultrasonic signal 41 transmitted by the ultrasonic transmitter 40 creates a collision avoidance range 42 around the cylindrical body 20. The infrared transmitter 50 is mounted in the holder member 22, and adapted for transmitting an infrared signal 51 through an opening 222 in the holder member 22 toward the outside. The infrared receiver 60 is mounted in the rotatable member 23, and adapted for receiving an infrared signal 51 from the infrared transmitter 50 of another electronic fence generator 10 through an opening 232 in the rotatable member 23.

In application, four or more than four electronic fence generators 10 are used depending on the size and shape of the lawn, and then the ground stakes 30 of the electronic fence generators 10 are fastened to the ground, and thus, the ultrasonic signals 41 and infrared signals 51 transmitted by the electronic fence generators 10 create a closed virtual electronic fence. For example, in the application example shown in FIG. 2, five electronic fence generators 10 are installed and operated to create a pentagonal electronic fence. Thus, an automatic lawn mower (not shown) capable of sensing ultrasonic signals and infrared signals can be restricted to the area defined by the electronic fence.

It's worth mentioning that the ultrasonic signal 41 transmitted by each electronic fence generator 10 is to prohibit the automatic lawn mower from bumping into the cylindrical body 20 of each electronic fence generator 10. In this application example, the collision avoidance range 42 is a circular range around the cylindrical body 20; however, the electronic fence generator 10 can also be configured to create a sector-like collision avoidance range 42 without surrounding the cylindrical body 20.

The applied electronic fence generators 10 can be sequentially numbered according to their arrangement, for example, in the configuration shown in FIG. 2, the applied electronic fence generators 10 are sequentially numbered from first to fifth. Each electronic fence generator 10 can be configured to provide (but not limited to) a number indicator 70 for indicating its number for easy identification.

Regardless of the number of electronic fence generators 10 used (hereinafter called as generators 10), which must include one generator 10 that can simply be set as the last generator, and the infrared signal 51 transmitted by the infrared transmitter 50 of the last generator contains a terminal identification code; the infrared signal 51 transmitted by the infrared transmitter 50 of each of the other generators contains number identification code corresponding to the number of the respective generator 10. The infrared signal 51 generated by the first generator 10 is transmitted toward the infrared receiver 60 of the second generator 10. When the second generator 10 determines the generator has received an infrared signal 51 from the first generator 10, it immediately transmits an infrared signal 51 toward the infrared receiver 60 of the third generator 10, and so on. When the last generator 10 determines the generator has received an infrared signal 51 from the antecedent generator 10, it immediately transmits an infrared signal 51 toward the infrared receiver 60 of the first generator 10, and thus, the first generator 10 can determine that these generators 10 and the respective infrared signals 51 have been connected together to form a closed loop.

In order to create the aforesaid infrared signal transmitting and receiving relationship, the infrared transmitter 50 and infrared receiver 60 of each generator 10 need to be respectively aimed at a specific signal transmitting direction and a specific signal receiving direction for transmitting or receiving an infrared signal 51 subject to the shape of the electronic fence to be created, and the signal transmitting direction and signal receiving direction of one same generator 10 should be different. The user can adjust the azimuth of each generator 10 during its installation in the group, thereby adjusting the signal transmitting direction of the infrared transmitter 50. The user can also rotate the rotatable member 23 of each generator 10 to adjust the angular position of the rotatable member 23, thereby adjusting the signal receiving direction of the infrared receiver 60.

One can image, as long as the infrared transmitter 50 and infrared receiver 60 of each generator 10 can be rotated relative to each other, the aforesaid adjustment function can be achieved. Therefore, the relative position of the infrared transmitter 50 and the infrared receiver 60 in each generator 10 can be swapped with each other, i.e., mount the infrared transmitter 50 in the rotatable member 23 and the infrared receiver 60 in the holder member 22. Or, another rotatable member can be used in each generator 10 to substitute for the holder member 22, i.e., the cylindrical body 20 comprises two rotatable members mounted on the base 21 and respectively rotatable relative to the base 21, and the infrared transmitter 50 and the infrared receiver 60 are respectively mounted in these two rotatable members.

It's worth mentioning that when managing an application implementation of the present invention, a fixed number of electronic fence generators can be used to create a fixed shape of virtual electronic fence. Under this condition, the infrared transmitter and infrared receiver of each electronic fence generator can be not rotatable and, every electronic fence generator does not need to be numbered with a respective identification number or to provide an identification number indicator, and every electronic fence generator itself has a recording function.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. An electronic fence generator, comprising:
a cylindrical body;
a ground stake downwardly extended from a bottom side of said cylindrical body;
an ultrasonic transmitter mounted in said cylindrical body and adapted for transmitting an ultrasonic signal to create a collision avoidance range around said cylindrical body;
an infrared transmitter mounted in said cylindrical body and adapted for transmitting an infrared signal in a signal transmitting direction; and
an infrared receiver mounted in said cylindrical body and adapted for receiving an infrared signal from another electronic fence generator in a signal receiving direction different from said signal transmitting direction.

2. The electronic fence generator as claimed in claim 1, wherein said cylindrical body comprises a base fixedly connected with said ground stake, and a rotatable member rotatable relative to said base; said infrared transmitter is mounted in said rotatable member.

3. The electronic fence generator as claimed in claim 1, wherein said cylindrical body comprises a base fixedly connected with said ground stake, and a rotatable member rotatable relative to said base; said infrared receiver is mounted in said rotatable member.

4. The electronic fence generator as claimed in claim 1, wherein said cylindrical body comprises a base fixedly connected with said ground stake, and two rotatable members respectively rotatable relative to said base; said infrared transmitter and said infrared receiver are respectively mounted in said two rotatable members.

5. The electronic fence generator as claimed in claim 1, wherein said collision avoidance range created by said ultrasonic transmitter is a circular range surrounding said cylindrical body.

6. The electronic fence generator as claimed in claim 1, wherein said electronic fence generator is encoded with an identification number; said infrared signal transmitted by said infrared transmitter comprises a number identification code corresponding to said identification number.

7. The electronic fence generator as claimed in claim 6, further comprising an identification number indicator adapted for indicating said identification number.

8. The electronic fence generator as claimed in claim 1, wherein said infrared signal transmitted by said infrared transmitter comprises a terminal identification code.
